(19) United States
(12) Patent Application Publication
(10) Pub. No.: US 2007/0160741 A1
(43) Pub. Date: Jul. 12, 2007

(54) Method Of Processing Garlic

(76) Inventors: Eliyahu Moreno, Moshav Sitriya (IL); Ziva Moreno, Moshav Sitriya (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/620,746

(22) Filed: Jan. 8, 2007

Related U.S. Application Data
(60) Provisional application No. 60/757,007, filed on Jan. 9, 2006.

(51) Int. Cl. A23L 1/223

(52) U.S. Cl. 426/638

(57) ABSTRACT

A method of making a ready-to-use frozen garlic product. Clean garlic cloves are minced into minced garlic and garlic juice, which is combined into garlic pulp. The garlic pulp is mixed with edible salt at a ratio of 13-25 grams of salt to every 100 grams of garlic pulp. A homogeneous mixture of garlic pulp and salt is produced. The homogeneous mixture is stored in containers of different sizes, such as jars, trays, and tubes. The containers are placed in freezing conditions, in temperatures ranging from −4° C. to some minimal freezing temperature, the minimal freezing temperature depending on the concentration of salt in the mixture of garlic pulp and salt. When taken out of the freezer, the homogeneous mixture is immediately ready for used.

### CROSS REFERENCE TO RELATED APPLICATIONS

This application claims the benefit under 35 USC 119(e) from U.S. provisional application 60/757,007 filed Jan. 9, 2006, the disclosure of which is included herein by reference.

### FIELD OF THE INVENTION

The present invention relates to an improved method of processing garlic and more particularly to an improved method of processing fresh garlic so as to enable storage keeping freshness, taste, smell and texture of the fresh garlic for a prolonged period of time.

### BACKGROUND OF THE INVENTION AND PRIOR ART

Many attempts have been made to store garlic in frozen and dry forms e.g. garlic powders, for later use. These forms, however, are not an adequate substitute for fresh garlic Many prior art methods include mixing garlic pulp into a mixture with water, and freezing the mixture into a hard and rigid composition.

U.S. Pat. No. 4,022,923 given to Sonja Berger, describes a method of mixing minced garlic with powdered garlic, an emulsifying agent and water Korean patent KR93002180B describes a process in which garlic cloves are heated to a temperature of 40-65° C. for 1-5 hours, cooled, sliced and soaked in a solution containing citric acid, ascorbic acid, phosphate salt, edible salt and glucose syrup After soaking, the sliced garlic is squashed and packed with a degassing agent or inert gas to obtain a final product of squashed garlic.

Thus there is a need for and it would be advantageous to have a method for processing garlic that does not use water and preserves freshness, taste, smell, texture and composition of the minced garlic. It is further desirable to be able to use the garlic product of the process immediately when needed.

### DEFINITIONS

The term “clean garlic clove” as used herein refers to a garlic clove after being separated from the bulb, pealed and washed.

The terms “minced”, “crushed” and “ground” are used herein interchangeably.

The term “edible salt” as used herein refers to sodium chloride or any other salt edible by humans.

### SUMMARY OF THE INVENTION

The term “garlic pulp” as used herein refers to clean garlic cloves which are crushed and/or minced into a mixture of minced garlic and juice.

The term “frozen garlic pulp” as used herein refers to garlic pulp only, with no other ingredients added, in a frozen or solid state. Typically, the frozen state is preferably a temperature of −10° C. or lower.

The term “immediately” as used herein referring to the time elapsed after mincing the “clean garlic cloves” is defined by the elapsed time preferably not exceeding thirty (30) minutes in room temperature, such that ingredients of the garlic, such as lecithin, are not lost.

The term “immediately” as used herein referring to the time elapsed after taking the garlic pulp out of the freezer is defined as not exceeding one (1) minute.

According to the teachings of an embodiment of the present invention there is provided a method of making a ready-to-use frozen garlic product. Clean garlic cloves are minced into minced garlic and garlic juice, which are blended into garlic pulp. The garlic pulp is mixed with edible salt at a ratio of 13-25 grams of salt to every 100 grams of garlic pulp. A homogeneous mixture of garlic pulp and salt is produced. The homogeneous mixture is preferably stored in containers of different sizes such as jars, trays, and tubes. The containers are placed in freezing conditions, at temperatures ranging from −4° C. to a minimal freezing temperature, the minimal freezing temperature depending on the concentration of salt in the homogeneous mixture. For a mixing ratio of 13-25 grams of salt to every 100 grams of garlic pulp, the minimal freezing temperature is between −18° C. and −23° C., respectively.

According to the teachings of another embodiment of the present invention there is provided a method of making a ready-to-use frozen garlic product. Clean garlic cloves are minced into minced garlic and garlic juice, which are combined into garlic pulp. Immediately after mincing the clean garlic cloves, the garlic pulp is frozen to at least a temperature which brings the garlic pulp to a solid state. A frozen garlic pulp is produced. At a later time, at least a portion of the frozen garlic pulp is defrosted. The defrosted garlic pulp is mixed with edible salt at a ratio of 13-25 grams of salt to every 100 grams of garlic pulp. A homogeneous mixture of garlic pulp and salt is produced. The homogeneous mixture is stored in containers of different sizes, such as jars, trays, and tubes. The containers are placed in freezing conditions, at temperatures ranging from −4° C. to a minimal freezing temperature, the minimal freezing temperature depends on the concentration of salt in the homogeneous mixture. For a mixing ratio of 13-25 grams of salt to every 100 grams of garlic pulp, the minimal freezing temperature is between −18° C. and −23° C., respectively.

According to the present invention there is provided a ready-to-use frozen garlic product, including garlic pulp and edible salt with a ratio of 13-25 grams of salt to every 100 grams of garlic pulp, thereby producing a homogeneous mixture of garlic pulp and salt, the frozen garlic product produced according to the methods as disclosed herein.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1 is a schematic flow diagram showing the process flow of a garlic processing method, in accordance with an embodiment of the present invention; and

FIG. 2 is a schematic flow diagram showing optional preliminary steps of a garlic processing method, in accordance with an embodiment of the present invention

### DESCRIPTION OF THE PREFERRED EMBODIMENTS

The present invention provides a method of processing garlic so as to enable storage of minced garlic in a frozen state for a prolonged period of time, while keeping the freshness, flavor, smell and texture of fresh garlic, such that the minced garlic can be used immediately once taken out of the freezing conditions. An intention of the present invention is to produce a natural product with no preservatives, no artificial additives or the like, and which is a product that is ready for immediate use.

Prior to processing the garlic, according to embodiments of the present invention a cleaning process is used. The process for cleaning garlic as follows is by way of example only, and any other suitable cleaning process may be used.
a) After the garlic is picked, the garlic is hung in a cool place to dry until the garlic leaves turn brown Once the leaves turned brown, the leaves are cut away from the garlic bulb.
b) The roots are cut away from the garlic bulb.
c) The garlic bulb is opened and the garlic cloves are separated—the stem inside the garlic bulb is discarded.
d) The cloves are thoroughly washed in water and the underneath part of the clove is cut and discarded.
e) The individual garlic cloves are peeled and the two top layers of each clove are discarded.

Before explaining embodiments of the invention in detail, it is to be understood that the invention is not limited in its application to the details of construction and the arrangement of the components set forth in the host description or illustrated in the drawings.

Unless otherwise defined, all technical and scientific terms used herein have the same meaning as commonly understood by one of ordinary skill in the art of the invention belongs. The methods and examples provided herein are illustrative only and not intended to be limiting.

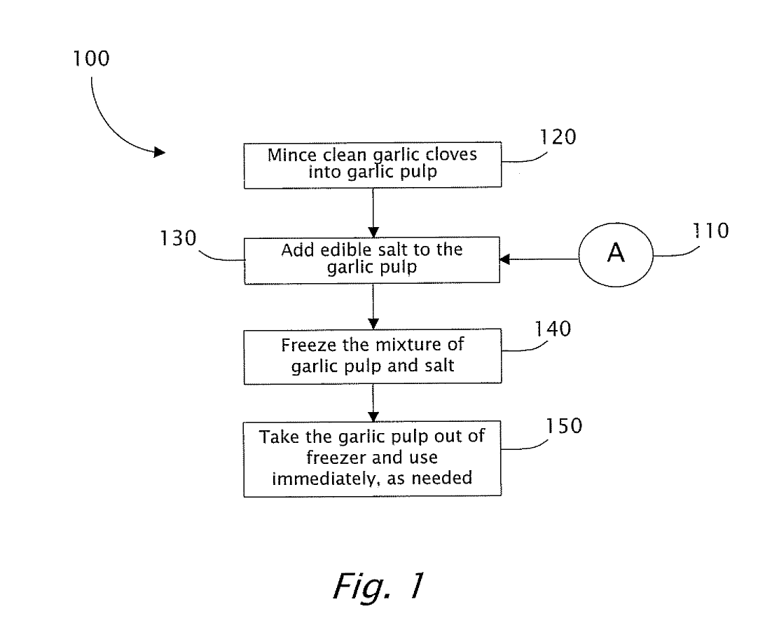

FIG. 1 is a schematic flow diagram showing the process flow of a garlic processing method 100, in accordance with an embodiment of the present invention. Garlic processing method 100 enables storage of minced garlic for a prolonged period of time, while keeping the freshness, flavor, smell and texture of the minced garlic as that of fresh garlic.

Garlic processing method 100 includes the following steps:
step 120: the clean garlic cloves are minced into minced garlic and garlic juice, which are combined into garlic pulp;
step 130: the garlic pulp is mixed with edible salt, at a ratio of 13-25 grams salt to every 100 grams of garlic pulp, resulting in a homogeneous mixture of garlic pulp and salt; and
step 140: the homogeneous mixture is preferably stored in jars, containers, trays or tubes of different sizes, and is frozen in temperatures ranging from −18° C. to −23° C. or higher. The lowest temperature at which the homogeneous mixture is stored depends on the concentration of salt in the homogeneous mixture. The more salt the homogeneous mixture contains, the lower the temperature in which the homogeneous mixture can be kept in. Preferably, the temperature the homogeneous mixture should be kept in is not higher than −4° C.

The homogeneous mixture can preferably be kept for a prolonged period of time of at least three (3) years. When a user needs to use the garlic pulp, the user extracts the needed amount of homogeneous mixture from the freezer in step 150. The garlic pulp is ready for immediate use, without the need for defrosting the homogeneous mixture. The garlic pulp is ready to be used having preserved the freshness, flavor, smell and texture as if the garlic was freshly minced.

It should be noted that the homogeneous mixture includes solely garlic and salt. The homogeneous mixture preferably contains less than 1% water most of which is sourced solely from the clean garlic cloves.

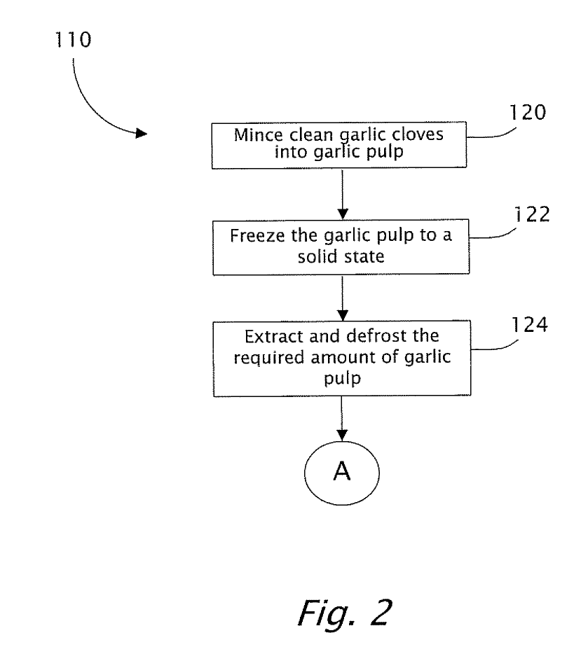

FIG. 2 is a schematic flow diagram showing optional preliminary steps 110 of a garlic processing method 100, in accordance with an embodiment of the present invention. When the clean garlic cloves are freshly minced in step 120, sometimes the freshly minced garlic is not immediately mixed with salt, according to process 100. To preserve the garlic characteristics and natural ingredients, immediately after the grinding step 120, the garlic pulp is frozen in step 122, at a temperature bringing the garlic pulp to a solid state. The temperature is typically −18° C. or below. If not immediately frozen some ingredients such as Lecithin may be lost or lose their characteristics.

When ready for being mixed with salt according with an embodiment of the present invention, the required amount of frozen garlic pulp is extracted and defrosted in step 124. Once defrosted, the garlic pulp is mixed with salt and frozen, according with step 130 and 140 of garlic processing method 100.

The invention being thus described in terms of embodiments and examples, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of making a ready-to-use frozen garlic product, comprising the steps of:
a) mincing clean garlic cloves to minced garlic and garlic juice;
b) combining said minced garlic and said garlic juice into garlic pulp;
c) mixing said garlic pulp with edible salt at a ratio of 13-25 grams of salt to every 100 grams of garlic pulp, thereby producing a homogeneous mixture of garlic pulp and salt; and
d) freezing said homogeneous mixture at a storage temperature selected within a temperature range between a minimal freezing temperature and −4° C., said minimal freezing temperature depending on the concentration of salt in said homogeneous mixture and being lower than −4° C.

2. The method of claim 1, wherein for said ratio of 13-25 grams of edible salt to every 100 grams of garlic pulp, said minimal freezing temperature is between −18° C. and −23° C., respectively.

3. The method of claim 1, wherein said homogeneous mixture in a container selected from the group of containers consisting of: jars, trays, tubes.

4. The method of claim 1, wherein at no step is water added to said homogeneous mixture.

5. A ready-to-use frozen garlic product, comprising garlic pulp and edible salt with a ratio of 13-25 grams of salt to every 100 grams of garlic pulp, thereby producing a homogeneous mixture of garlic pulp and salt, the ready-to-use frozen garlic product prepared according to the method of claim 1.

6. The ready-to-use frozen garlic product of claim 5, wherein said product includes solely garlic and salt, said product includes less than 1% water, said water sourced mostly in said garlic pulp.

7. A method of making a ready-to-use frozen garlic product, comprising the steps of:
a) mincing clean garlic cloves to minced garlic and garlic juice and combining said minced garlic and said garlic juice into garlic pulp;
b) immediately after said mincing, freezing said garlic pulp, at a freezing temperature which brings said garlic pulp to a solid state, thereby producing frozen garlic pulp;
c) defrosting at least a portion of said frozen garlic pulp;
d) mixing said garlic pulp with edible salt at a ratio of 13-25 grams of salt to every 100 grams of garlic pulp, thereby producing a homogeneous mixture of garlic pulp and salt; and
e) storing said homogeneous mixture in containers of different sizes selected from the group of containers consisting of: jars, trays, tubes, and freezing said homogeneous mixture at a storage temperature selected within a temperature range between a minimal freezing temperature and −4° C., said minimal freezing temperature depending on the concentration of salt in said homogeneous mixture and being lower than −4° C.

8. The method of claim 7, wherein for said ratio of 13-25 grams of edible salt to every 100 grams of garlic pulp, said minimal freezing temperature is between −18° C. and −23° C., respectively.

9. A ready-to-use frozen garlic product, comprising garlic pulp and edible salt with a ratio of 13-25 grams of salt to every 100 grams of garlic pulp, thereby producing a homogeneous mixture of garlic pulp and salt, the ready-to-use frozen garlic product prepared according to the method of claim 7.

10. The ready-to-use frozen garlic product of claim 9, wherein said product includes solely garlic and salt, said product includes less than 1% water, said water sourced mostly in said garlic pulp.
